(19) United States
(12) Patent Application Publication
(10) Pub. No.: US 2012/0206091 A1
(43) Pub. Date: Aug. 16, 2012

(54) COMMUNICATION SYSTEM AND DEVICES IN THE COMMUNICATION SYSTEM

(75) Inventors: Hidenori TANAKA, Tokyo (JP); Yoshinori HIROSE, Tokyo (JP)

(73) Assignee: MITSUMI ELECTRIC CO., LTD., Tokyo (JP)

(21) Appl. No.: 13/361,052

(22) Filed: Jan. 30, 2012

(30) Foreign Application Priority Data
Feb. 10, 2011 (JP) 2011-027203

(51) Int. Cl. H04L 25/34; H02J 7/00

(52) U.S. Cl. 320/107; 375/286

(57) ABSTRACT

A communication system including a first device and a second device that are connected by a single signal line in which serial communication is performed by using a first level, a second level and a middle level between the first level and the second level, wherein the first device transmits a clock to the second device by repeating the first level and the middle level; the second device transmits information to the first device based on whether the second device outputs the second level during each period of the middle level in the clock; and when the second device does not transmit information, the first device transmits information to the second device based on whether the first device outputs the second level during each period of the middle level in the clock.

### CROSS-REFERENCE TO RELATED APPLICATION

The present application is based upon and claims the benefit of priority of Japanese Patent Application No. 2011-027203, filed on Feb. 10, 2011, the entire contents of which are incorporated herein by reference.

### BACKGROUND OF THE INVENTION

1. Field of the Invention

The present invention relates to a communication system, and devices in the communication system for performing bidirectional serial communication.

2. Description of the Related Art

As a conventional technique, there is a communication system for performing bidirectional serial communication. For example, Japanese Laid-Open Patent application No. 7-95248 (to be referred to as patent document 1, hereinafter) discloses a communication system for performing bidirectional communication using two bus lines in which data and a clock are multiplexed in a time-division manner and transmitted over one bus line and another bus line is used for transmitting/receiving decisions.

More specifically, using the technique shown in the patent document 1, when transmitting a signal, a latch circuit is synchronized with a clock signal from a clock circuit. A power source voltage Vcc of IN terminal is output to a contact point “a” of a switch by data H from a data input unit, and the contact point “a” is set at a divided voltage value of resistances R1 and R2 by data L. The switch is switched between “a” and “b” by a clock signal in which data is output from “a” and a clock signal is output from “b”. A signal is transmitted to a data/clock transmission line via a transmit/receive switch. When receiving a signal, a signal input to a separation circuit by the transmit/receive switch is separated into data and a clock signal by level determination. Data are latched and waveform-shaped by a latch/shaping circuit and are output. When transmitting a signal, a decoder calculates a level of a transmit/receive decision line and a transmit request input H, and outputs H, so that the transmit/receive switch is changed to a transmission side, and the transmit/receive decision line is changed to L. Then, the data and the clock signal are time-division multiplexed and sent over the bus line.

In the conventional technique, there is a problem in that a data/clock transmission line and a transmit/receive decision line are necessary for performing bidirectional serial communication, and bidirectional serial communication cannot be performed by using a single signal line.

### SUMMARY OF THE INVENTION

Accordingly, the present invention is conceived in view of the above-mentioned problem, and an object of the present invention is to provide a communication system and devices for performing bidirectional serial communication using a single signal line.

According to an embodiment, there is provided a communication system including a first device and a second device that are connected by a single signal line in which serial communication is performed by using a first level, a second level and a middle level between the first level and the second level, wherein

the first device transmits a clock to the second device by repeating the first level and the middle level;

the second device transmits information to the first device based on whether the second device outputs the second level during each period of the middle level in the clock; and

when the second device does not transmit information, the first device transmits information to the second device based on whether the first device outputs the second level during each period of the middle level in the clock.

According to another embodiment, there is provided a device in a communication system including a first device and a second device that are connected by a single signal line in which serial communication is performed by using a first level, a second level and a middle level between the first level and the second level, the device corresponding to the first device, and the device including:

a unit configured to transmit a clock to the second device by repeating the first level and the middle level; and

a unit configured to transmit information to the first device based on whether to output the second level during each period of the middle level in the clock when the second device does not transmit information.

According to still another embodiment, there is provided a device in a communication system including a first device and a second device that are connected by a single signal line in which serial communication is performed by using a first level, a second level and a middle level between the first level and the second level, the device corresponding to the second device and the device including:

a unit configured to receive a clock in which the first level and the middle level are repeated from the first device; and

a unit configured to transmit information to the first device based on whether to output the second level during each period of the middle level of the clock.

Other objects and further features of the present invention will be apparent from the following detailed description when read in conjunction with the accompanying drawings.

### BRIEF DESCRIPTION OF THE DRAWINGS

FIG. 1 is a block diagram of an embodiment of a communication system;

FIG. 2 is a circuit configuration diagram of an embodiment of signal input-output units of a battery monitor IC and a protection IC;

FIG. 3 is a signal timing chart in a control command transmission mode;

FIG. 4 is a signal timing chart in a status inquiry command receiving mode;

FIG. 5 is a signal timing chart of an interruption receiving mode;

FIG. 6 is a state transition diagram in the battery monitor IC;

FIG. 7 is a circuit configuration diagram of an embodiment of the signal input-output unit of the protection IC;

FIG. 8 is a signal waveform diagram for each part shown in FIG. 7;

FIG. 9 is a block diagram of a shift register;

FIG. 10 is a signal waveform diagram for each part shown in FIG. 7 in the control command transmission mode;

FIG. 11 is a signal waveform diagram for each part shown in FIG. 7 in the status inquiry command receiving mode;

FIG. 12 is a signal waveform diagram for each part shown in FIG. 7 in the interruption receiving mode; and

FIG. 13 is a flowchart of signal output processing performed by the protection IC.

### DESCRIPTION OF THE PREFERRED EMBODIMENTS

In the following, an embodiment of the present invention is described with reference to figures.

<Outline of Embodiment>

In an embodiment, there is provided a communication system including a first device (11) and a second device (12) that are connected by a single signal line in which serial communication is performed by using a first level, a second level and a middle level between the first level and the second level, wherein

the first device (11) transmits a clock to the second device (12) by repeating the first level and the middle level;

the second device (12) transmits information to the first device (11) based on whether the second device (12) outputs the second level during each period of the middle level in the clock; and

when the second device (12) does not transmit information, the first device (11) transmits information to the second device based on whether the first device (11) outputs the second level during each period of the middle level in the clock.

In the communication system, the first device (11) may transmit information to the second device (12) after outputting the middle level first. In addition, the first device (11) may receive information transmitted from the second device (12) after outputting the second level first. In addition, the second device (12) may transmit information to the first device (11) after outputting the second level first. In addition, the first device (11) may receive information transmitted from the second device (12) if the first device (11) receives the second level within a predetermined period after outputting the middle level or the second level first.

The first device (11) may be a battery monitor integrated circuit configured to monitor charging and discharging of a secondary battery (10). The second device (12) may be a protection integrated circuit configured to control charging and discharging of the secondary battery (10).

Also, in an embodiment, there is provided a device (11) in a communication system including a first device (11) and a second device (12) that are connected by a single signal line in which serial communication is performed by using a first level, a second level and a middle level between the first level and the second level, the device corresponding to the first device, and the device (11) including:

a unit (R11, M12) configured to transmit a clock to the second device (12) by repeating the first level and the middle level; and

a unit (R12, M11) configured to transmit information to the first device (11) based on whether to output the second level during each period of the middle level in the clock when the second device (12) does not transmit information.

Also, in an embodiment, there is provided a device (12) in a communication system including a first device (11) and a second device (12) that are connected by a single signal line in which serial communication is performed by using a first level, a second level and a middle level between the first level and the second level, the device corresponding to the second device and the device including:

a unit (33) configured to receive a clock in which the first level and the middle level are repeated from the first device (11); and

a unit (M13) configured to transmit information to the first device (11) based on whether to output the second level during each period of the middle level of the clock.

According to the embodiment, bidirectional communication can be performed using one signal line.

The above reference symbols are merely examples, and embodiments described herein are not limited by the reference symbols show in figures.

<Block Configuration of the Communication System>

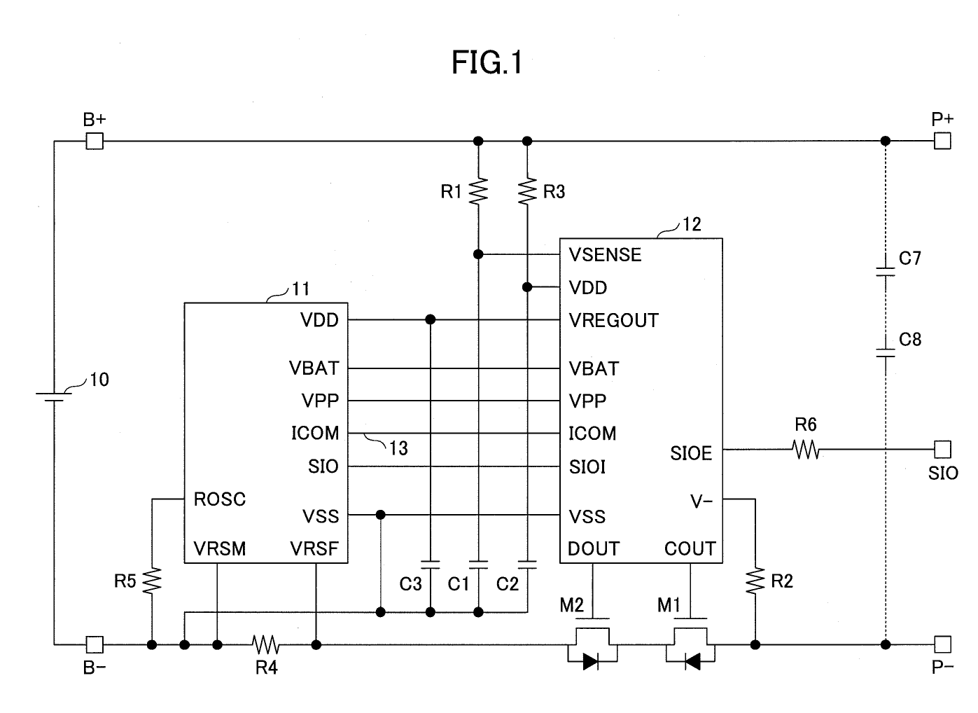

FIG. 1 shows a block diagram of an embodiment of the communication system. As shown in FIG. 1, a secondary battery 10 such as a lithium-ion battery is connected between terminals B+ and B−. The terminal B+ is connected to a terminal P+, and the terminal B− is connected to a terminal P− via a resistance R4 and MOS transistors M2 and M1. A load or a charging circuit is connected between terminals P+ and P−.

Voltages of both sides of the resistance R4 are supplied to terminals VRSM and VRSF of a battery monitor IC (Integrated Circuit) 11, that is a first device, such that the battery monitor IC 11 detects charge/discharge current of the secondary battery 10 based on a voltage difference between the terminals VRSM and VRSF. Also, a battery voltage of the secondary battery 10 is supplied to a terminal VBAT via a protection IC 12, so that the battery monitor IC 11 detects the voltage of the terminal VBAT as a voltage of the secondary battery 10. In addition, power that is stabilized by the protection IC 12 is supplied to the terminal VDD of the battery monitor IC 11. A microcomputer is embedded in the battery monitor IC 11 so that the battery monitor IC 11 calculates a battery remaining amount of the secondary battery 10 by accumulating charge-discharge currents, and performs overvoltage detection and overcurrent detection in charge and discharge of the secondary battery 10, so as to control the protection IC 12 based on the detection result.

The protection IC 12 that is a second device stabilizes a voltage to be supplied to the terminal VDD from the secondary battery 10 via a resistance R3, and supplies the stabilized voltage to the battery monitor IC 11 from the terminal VREGOUT. Also, the battery voltage of the secondary battery 10 is supplied to the terminal VSENSE via the resistance R1. The battery voltage is divided and supplied to the battery monitor IC 11 from the terminal VBAT. The protection IC 12 compares the voltage of the terminal VSENSE with an over-charging threshold and an over-discharging threshold. If the voltage of the terminal VSENSE exceeds the over-charging threshold, the protection IC 12 turns off the MOS transistor M1 as an abnormal state. If the voltage of the terminal VSENSE falls below the over-discharging threshold, the protection IC 12 turns off the MOS transistor M2 as an abnormal state. In addition to that, the protection IC 12 changes ON/OFF of the MOS transistors M1 and M2 according to control from the battery monitor IC 11 so as to perform charge-discharge control of the secondary battery 10.

The terminal ICOM of the battery monitor IC 11 and the terminal ICOM of the protection IC 12 are connected by a signal line 13, so that bidirectional three-value serial communication is performed between the battery monitor IC 11 and the protection IC 12.

<Configuration of Input-Output Circuit of the Communication System>

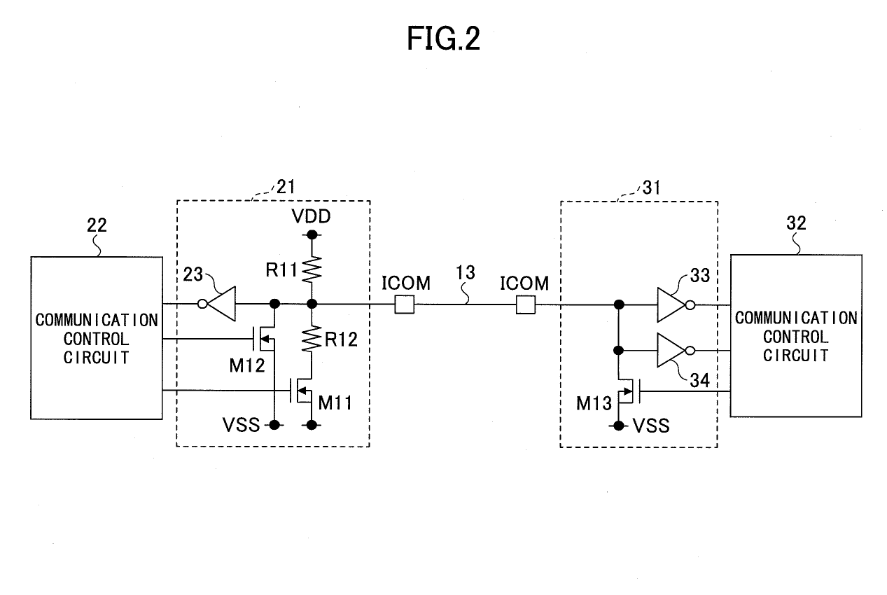

FIG. 2 shows a circuit configuration diagram of an embodiment of a signal input-output unit (21 and 22) of the battery monitor IC 11 and a signal input-output unit (31 and 32) of the protection IC 12. As shown in FIG. 2, the terminal ICOM of the battery monitor IC 11 is provided with an input-output circuit 21 of the battery monitor IC 11. In the input-output circuit 21, the terminal ICOM of the battery monitor IC 11 is connected to the power source VDD via a resistance R11, and is connected to a drain of an n-channel MOS transistor M11 via a resistance R12, and a source of the MOS transistor M11 is connected to a power source VSS. A middle level output signal is supplied to a gate of the MOS transistor M11 from a communication control circuit 22.

Also, the terminal ICOM of the battery monitor IC 11 is connected to a drain of the n-channel MOS transistor M12, and a source of the MOS transistor M12 is connected to the power source VSS. A low level output signal is supplied to a gate of the MOS transistor M12 from the communication control circuit 22 in the battery monitor IC 11. In addition, the terminal ICOM of the battery monitor IC 11 is connected to the communication control circuit 22 via an inverter 23. The inverter 23 has a first threshold that is an intermediate voltage between the middle level and the low level. When the terminal ICOM is at the low level, the inverter 23 supplies a high level to the communication control circuit 22. When the terminal ICOM is at the middle level or the high level, the inverter 23 supplies the low level to the communication control circuit 22.

Also, the terminal ICOM of the protection IC 12 is provided with an input-output circuit 31 of the protection IC 12. In the input-output circuit 31, the terminal ICOM of the protection IC 12 is connected to a drain of the n-channel MOS transistor M13, and a source of the MOS transistor M13 is connected to the power source VSS. A low level output signal is supplied to the gate of the MOS transistor M13 from the communication control circuit 32 in the protection IC 12.

In addition, the terminal ICOM of the protection IC 12 is connected to the communication control circuit 22 via inverters 33 and 34. The inverter 33 has a first threshold that is an intermediate voltage between the middle level and the low level. When the terminal ICOM is at the low level, the inverter 33 supplies the high level to the communication control circuit 22. When the terminal ICOM is at a level equal to or higher than the middle level, the inverter 33 supplies the low level to the communication control circuit 22. The inverter 34 has a second threshold that is an intermediate voltage between the high level and the middle level. When the terminal ICOM is at a level equal to or less than the middle level, the inverter 34 supplies the high level to the communication control circuit 22. When the terminal ICOM is at the high level, the inverter 34 supplies the low level to the communication control circuit 22.

When the battery monitor IC 11 outputs a high level signal from the terminal ICOM, the battery monitor IC 11 supplies a signal of a value 0 to the MOS transistors M11 and M12. When the battery monitor IC 11 outputs a low level signal from the terminal ICOM, the battery monitor IC 11 supplies a signal of a value 0 to the MOS transistor M11, and supplies a signal of a value 1 to the MOS transistor M12. When the battery monitor IC 11 outputs a middle level signal from the terminal ICOM, the battery monitor IC 11 supplies a signal of a value 1 to the MOS transistor M11, and supplies a signal of a value 0 to the MOS transistor M12.

During a period in which the terminal ICOM is at the middle level, when the protection IC 12 outputs a low level signal from the terminal ICOM, the protection IC 12 supplies a signal of a value 1 to the MOS transistor M13.

<Control Command Transmission Mode>

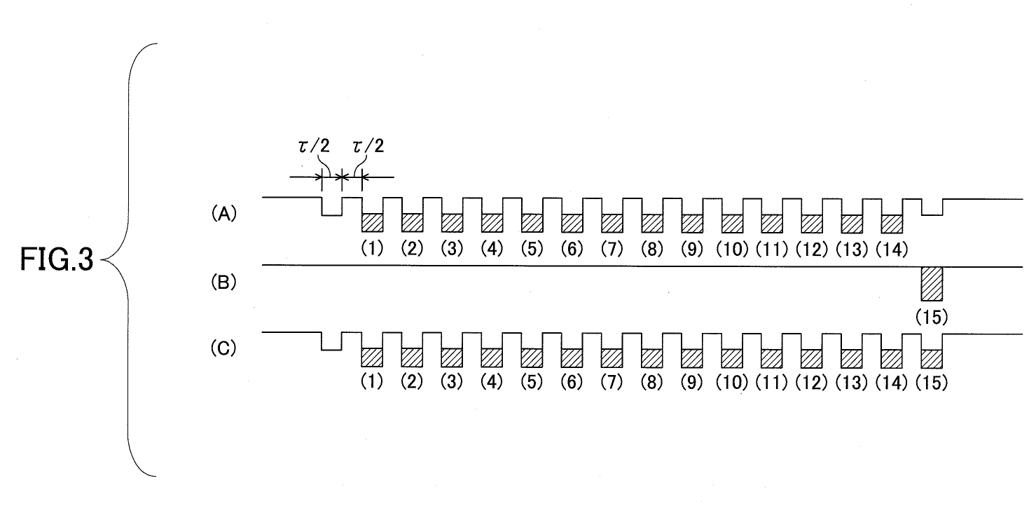

FIG. 3 shows a signal timing chart in a control command transmission mode in which a control command is transmitted from the battery monitor IC 11 to the protection IC 12.

First, as shown in (A) of FIG. 3, the battery monitor IC 11 sets the terminal ICOM at the middle level for a predetermined period τ/2 (several tens of p seconds, for example), and next, sets the terminal ICOM at the high level for the predetermined period τ/2. The battery monitor IC 11 reports the control command transmission mode to the protection IC 12 using the middle level, and reports one clock cycle to the protection IC 12 using the period τ of the middle level and the high level. In the figure, the shaded area indicates either one of the middle level and the low level.

After that, the predetermined period of the middle level or low level and the predetermine period of the high level are repeated 14 times, for example, a clock is included and that a control command of 14 bits is transmitted using the middle level or the low level shown as (1)-(14) in the figure. Each bit of the middle level has a value of 1 and each bit of the low level has a value of 0. In the 14 bits, odd bits (1), (3), (5), (7), (9) and (11) are values of bits of the control command, and even bits (2), (4), (6), (8), (10) and (12) are inverted values of the preceding odd bits (1), (3), (5), (7), (9) and (11) respectively. The odd bit (13) is a check bit as an odd parity of odd bits (1), (3), (5), (7), (9) and (11), and the even bit (14) is an inverted value of the check bit. That is, the control bits are actually formed by 7 bits including the check bit. As the control command, there are control of ON/OFF for the MOS transistor M1, control of ON/OFF for the MOS transistor M2, and the like.

After that, as shown in (15) of (B) of FIG. 3, at the timing in which the battery monitor IC 11 sets the terminal ICOM at the middle level, the protection IC 12 reports a parity bit (15) to the battery monitor IC 11 by setting the terminal ICOM at the high level or the low level for the predetermined period τ/2. The parity bit (15) has a value of an odd parity generated from the received odd bits (1), (3), (5), (7), (9), (11) and (13). In this embodiment, when the control command is received normally, the parity bit (15) is set to the low level. When the control command is not received normally, the parity bit (15) is set to the high level. Accordingly, the terminals ICOM of the battery monitor IC 11 and the protection IC 12 come into a signal status shown in (C) of FIG. 3.

<Status Inquiry Command Receiving Mode>

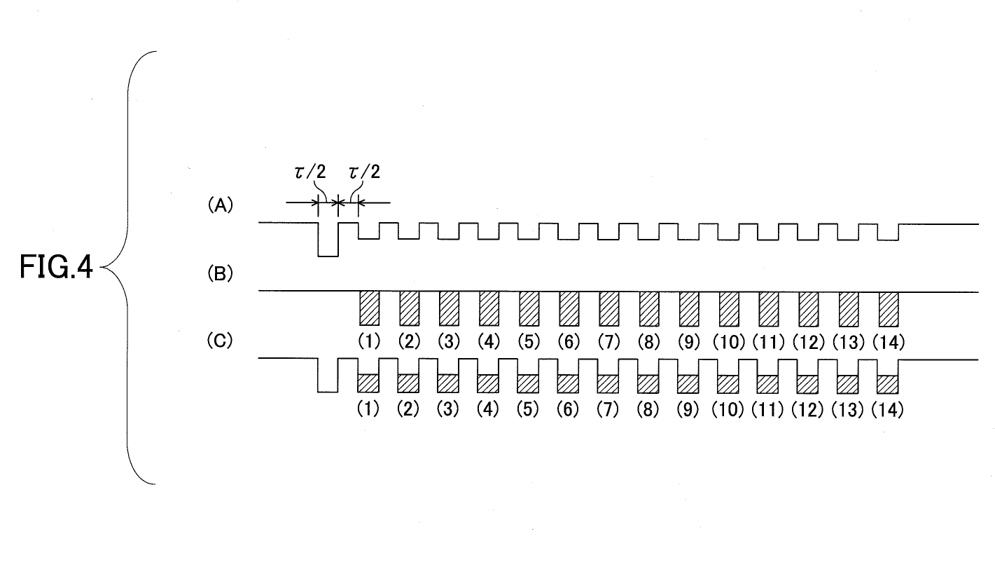

FIG. 4 shows a signal timing chart of the status inquiry command receiving mode in which the battery monitor IC 11 sends an inquiry about a status to the protection IC 12, and receives status sent from the protection IC 12.

First, as shown in (A) of FIG. 4, the battery monitor IC 11 sets the terminal ICOM at the low level for the predetermined period τ/2. Next, the battery monitor IC 11 sets the terminal ICOM at the high level for the predetermined period τ/2. By setting the terminal ICOM at the low level, the battery monitor IC 11 reports the status inquiry command receiving mode to the protection IC 12, and the battery monitor IC 11 reports one clock period using the period τ of the middle level and the high level. After that, a clock is transmitted by repeating the predetermined period of the middle level and the predetermine period of the high level 14 times, for example.

After that, at the timing in which the battery monitor IC 11 sets the terminal ICOM at the middle level, the protection IC 12 transmits a status of 14 bits of the high level or the low level indicated by (1)-(14) in (B) of FIG. 4. Each bit of the high level has a value of 1, and each bit of the low level has a value of 0. In the 14 bits, bits (1)-(13) are values of each bit of the status, and the bit (14) is a check bit as an odd parity of bits (1)-13). That is, the status is actually formed by 14 bits including the check bit. Accordingly, the terminals ICOM of the battery monitor IC 11 and the protection IC 12 come into a signal state shown in (C) of FIG. 4. As the status, there are status of ON/OFF for the MOS transistor M1, status of ON/OFF for the MOS transistor M2, and the like.

<Interruption Receiving Mode>

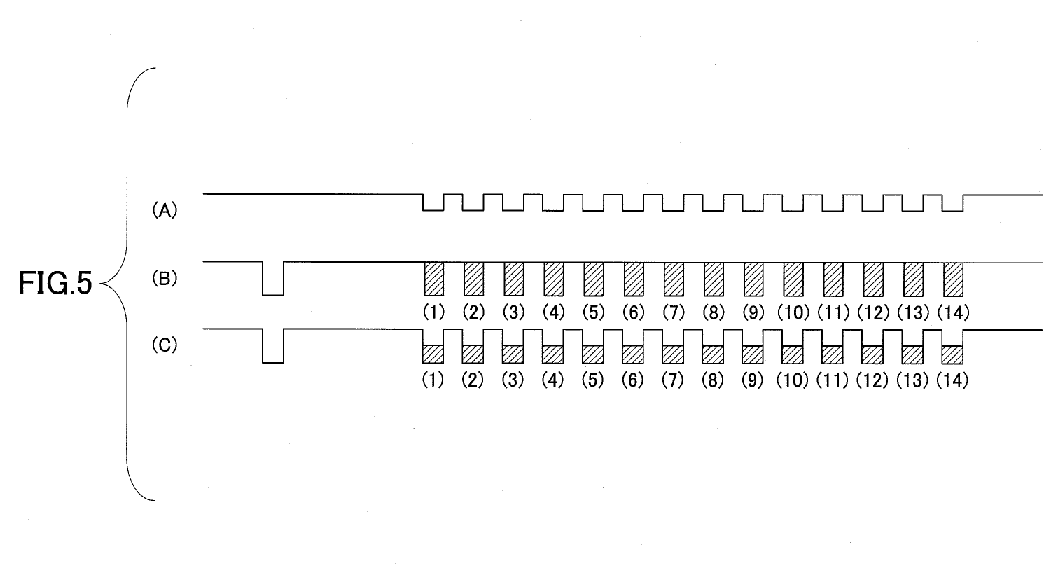

FIG. 5 shows a signal timing chart of an interruption receiving mode in which the protection IC 12 causes an interrupt in the battery monitor IC 11, and the battery monitor IC 11 receives a status transmitted from the protection IC 12.

First, as shown in (B) of FIG. 5, the protection IC 12 sets the terminal ICOM at the low level for the predetermined period τ/2. By setting the terminal ICOM at the low level, the protection IC 12 reports to the battery monitor IC 11 that the current mode is the interruption receiving mode.

By receiving the report, as shown in (A) of FIG. 5, the battery monitor IC 11 transmits a clock by repeating a cycle 14 times, for example, in which the cycle includes setting the terminal ICOM at the middle level for the predetermined period τ/2 and setting the terminal ICOM at the high level for the predetermined period τ/2.

After that, at the timing in which the battery monitor IC 11 sets the terminal ICOM at the middle level, the protection IC 12 reports a status of 14 bits of high level or low level (indicated as (1)-(14) in (B) of FIG. 5). Each bit of the high level has a value of 1, and each bit of the low level has a value of 0. In the 14 bits, bits (1)-(13) are values of each bit of the status, and the bit (14) is a check bit as an odd parity of bits (1)-(13). That is, the status is actually formed by 14 bits including the check bit. Accordingly, the terminals ICOM of the battery monitor IC 11 and the protection IC 12 comes into a signal state shown in (C) of FIG. 5.

<Status Transition Diagram of Battery Monitor IC>

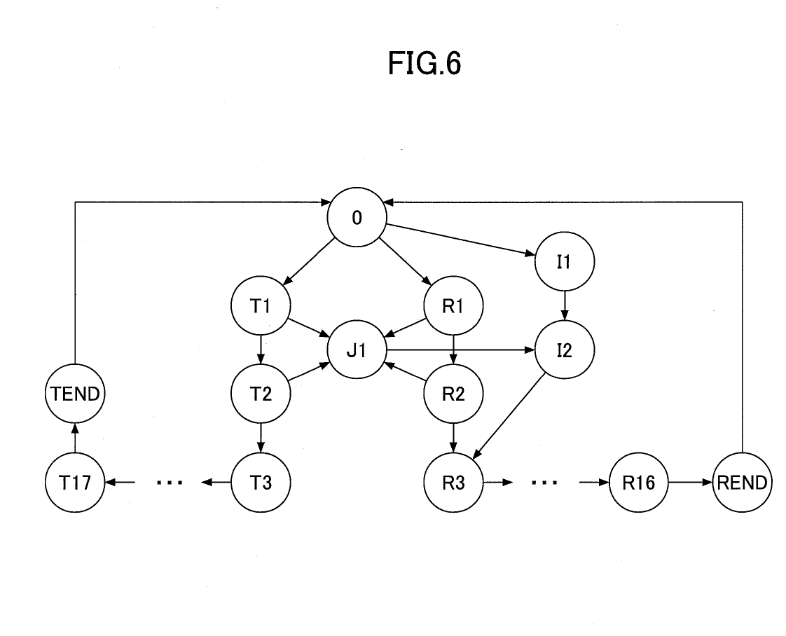

FIG. 6 shows a status transition diagram in the battery monitor IC 11. As shown in FIG. 6, “0” sequence is the initial status. When the control command transmission mode is started in the battery monitor IC 11, the status changes from the “0” sequence to the “T1” sequence. If there is no problem, the status goes back to the “0” sequence via sequences from “T1” sequence to “TEND” sequence in order with the clock period.

When the status inquiry command receiving mode is started in the battery monitor IC 11, the status changes from “0” sequence to “R1” sequence. If there is no problem, the status goes back to the “0” sequence via sequences from “R1” sequence to “REND” sequence in order with the clock period.

When the battery monitor IC 11 detects the low level of the terminal ICOM, the mode is changed to the interruption receiving mode, so that the status of the battery monitor IC 11 changes from the “0” sequence to the “I1” sequence. Then, the status goes back to the “0” sequence via “I1” sequence, “I2” sequence, and “R3” sequence to “REND” sequence in order.

When the battery monitor IC 11 detects the low level of the terminal ICOM in any of the “T1” sequence, the “T2” sequence, the “R1” sequence and the “R2” sequence, the status changes to “J1” sequence. This status transition occurs when the control command transmission mode or the status inquiry command receiving mode conflicts with the interruption receiving mode.

In the present embodiment, in order to avoid the conflict, the priority of the interruption receiving mode is set higher than that of the control command transmission mode and the status inquiry command receiving mode. Accordingly, the status of conflict of “J1” sequence is changed to “I2” sequence. After that, the status goes back to the “0” sequence via sequences from “R3” sequence to “REND” sequence in order.

<Configuration of Signal Input-Output Unit of the Protection IC>

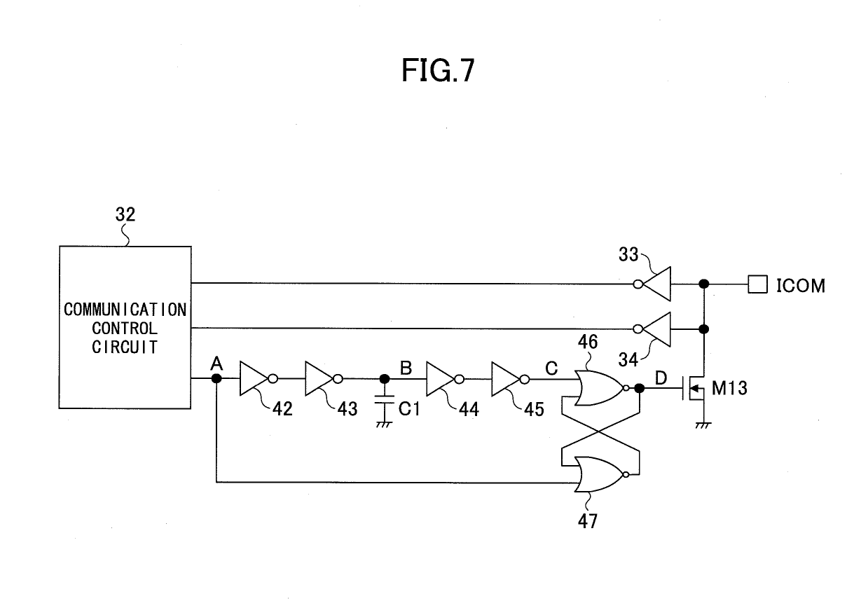

FIG. 7 shows a circuit configuration diagram of an embodiment of the signal input-output unit of the protection IC 12. In FIG. 7, the same reference symbols are assigned to parts the same as shown in FIG. 2. In FIG. 7, an input signal from the terminal ICOM of the protection IC 12 is supplied to the communication control circuit 32 via the inverters 33 and 34.

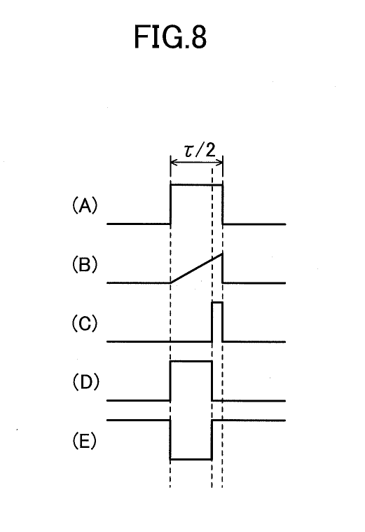

The communication control circuit 32 separates a clock of the input signal supplied from the inverter 33, and outputs a pulse signal having a high level period of τ/2 as shown in (A) of FIG. 8, in synchronization with the separated clock, at a timing in which the low level should be output in the status of 14 bits. The pulse signal output by the communication control circuit 32 is supplied to a NOR circuit 46 via the inverters 42, 43, 44 and 45, and supplied to a NOR circuit 47.

The connection point between the inverters 43 and 44 is grounded with a condenser Cl. The voltage of the condenser C1 becomes a slanted waveform as shown in (B) of FIG. 8 by the pulse signal. Accordingly, the pulse width of the output signal of the inverter 45 is reduced as shown in (C) of FIG. 8.

The output of the NOR circuit 46 is supplied to the gate of the MOS transistor M13 and supplied to an input terminal of the NOR circuit 47. Therefore, as shown in (D) of FIG. 8, the pulse width of the output of the NOR circuit 46 becomes narrower than that of the output pulse signal of the communication control circuit 32. The MOS transistor M13 is turned on during the period of high level of the pulse signal output by the NOR circuit 46, so that the terminal ICOM comes into the low level in synchronization with the clock as shown in (E) of FIG. 8. That is, the pulse width in the low level period of (E) of FIG. 8 becomes narrower than the pulse width (τ/2) of the output pulse signal of the communication control circuit 32. If the pulse width of the low level period output by the protection IC 12 shown in (E) of FIG. 8 is τ/2, all clock information output by the battery monitor IC 11 in the middle level disappears. Therefore, the pulse width of the low level period output by the protection IC 12 shown in (E) of FIG. 8 is set to be narrower than τ/2 such that all of the clock information output by the battery monitor IC 11 in the middle level does not disappear.

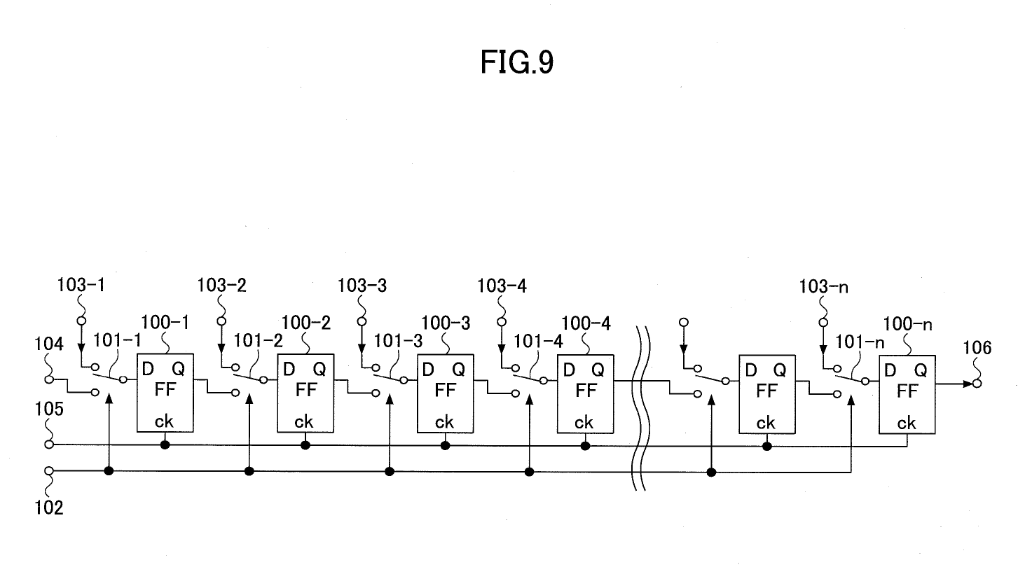

The communication control circuit 32 shown in FIG. 7 is provided with a shift register shown in FIG. 9. The shift register includes n stages of D type flip-flops 100-1˜100-n and switches 101-1˜101-n each of which is connected to a D input terminal of each flip-flop. When a signal of value 0 is supplied to the terminal 102 for example, the switches 101-1˜101-n are connected to the terminals 103-1˜103-n, and a status of n bits supplied from the terminals 103-1˜103-n is set in the flip-flops 100-1˜100-n based on clock input from the terminal 105.

After that, the value of the terminal 102 becomes 1, so that the switch 101-1 connects the D input terminal of the flip-flop 100-1 to the terminal 104, and switches 101-2˜101-n connect D input terminals of the flip-flops 100-2˜100-n to Q output terminals of the flip-flops 100-1˜100-n-1 of a former stage. Accordingly, a shift register is formed. A clock that the communication control circuit 32 separates from an input signal of the terminal ICOM is input to the terminal 105, so that the clock is supplied to the clock input terminals of the flip-flops 100-1˜100-n. Due to the input of the clock, the status of n bits set in the flip-flops 100-1˜100-n is shifted in the flip-flops so as to be serially output from the terminal 106.

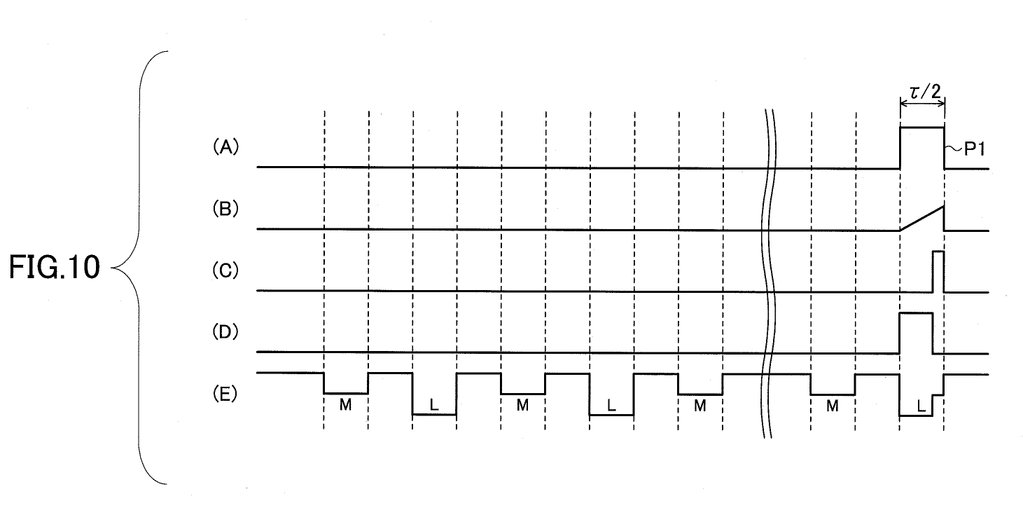

(A)-(E) of FIG. 10 show waveforms of an input of the inverter 42, a voltage of the condenser C1, an output of the inverter 45, an output of the NOR circuit 47 and the terminal ICOM shown in FIG. 7 respectively in the control command transmission mode. In this embodiment, the protection IC 12 supplies a pulse P1 of the high level to the inverter 42 as shown in (A) of FIG. 10 in order to perform low level output from the terminal ICOM. Then, as shown in (E) of FIG. 10, the level of the terminal ICOM becomes low in the first half of the period τ/2 of the pulse P1 and becomes middle after that.

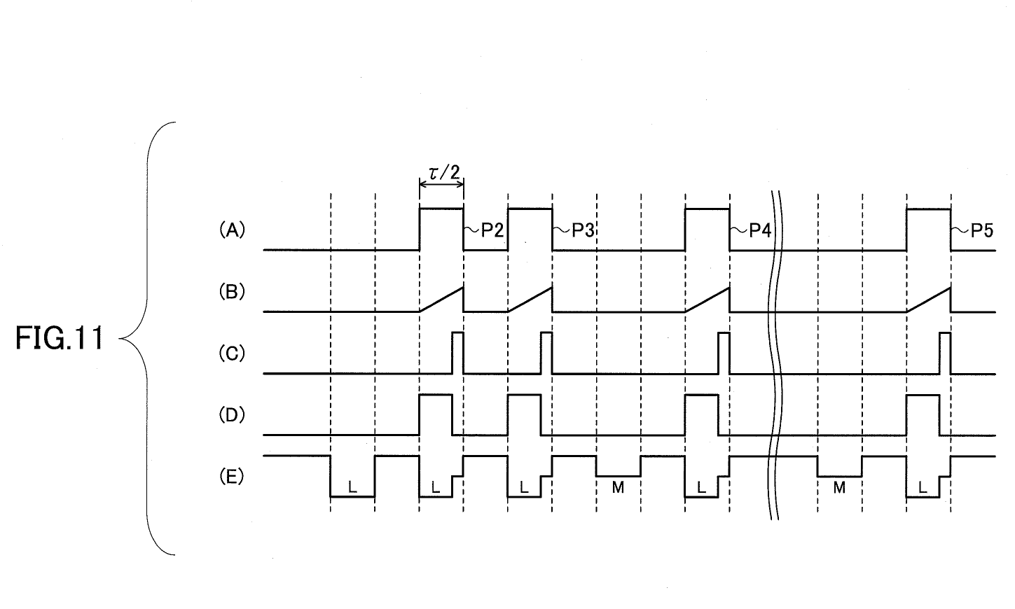

(A)-(E) of FIG. 11 show waveforms of an input of the inverter 42, a voltage of the condenser C1, an output of the inverter 45, an output of the NOR circuit 47 and the terminal ICOM shown in FIG. 7 respectively in the status inquiry command receiving mode. In this embodiment, the protection IC 12 supplies pulses P2˜P5 of high level to the inverter 42 as shown in (A) of FIG. 11 in order to perform low level output from the terminal ICOM. Then, as shown in (E) of FIG. 11, the level of the terminal ICOM becomes low in the first half of each period τ/2 of the pulses P2˜P5 and becomes middle after that.

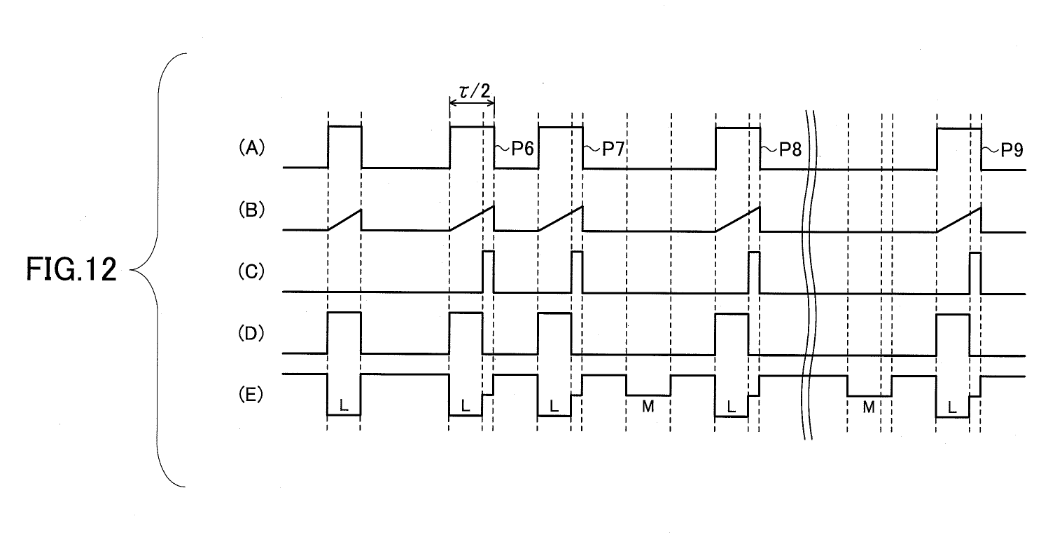

(A)-(E) of FIG. 12 show waveforms of an input of the inverter 42, a voltage of the condenser C1, an output of the inverter 45, an output of the NOR circuit 47 and the terminal ICOM shown in FIG. 7 respectively in the interruption receiving mode. In this embodiment, the protection IC 12 supplies pulses P6˜P9 of high level to the inverter 42 as shown in (A) of FIG. 12 in order to perform low level output from the terminal ICOM. Then, as shown in (E) of FIG. 12, the level of the terminal ICOM becomes low in the first half of each period τ/2 of the pulses P6˜P9 and becomes middle after that.

<Signal Output Processing of the Protection IC>

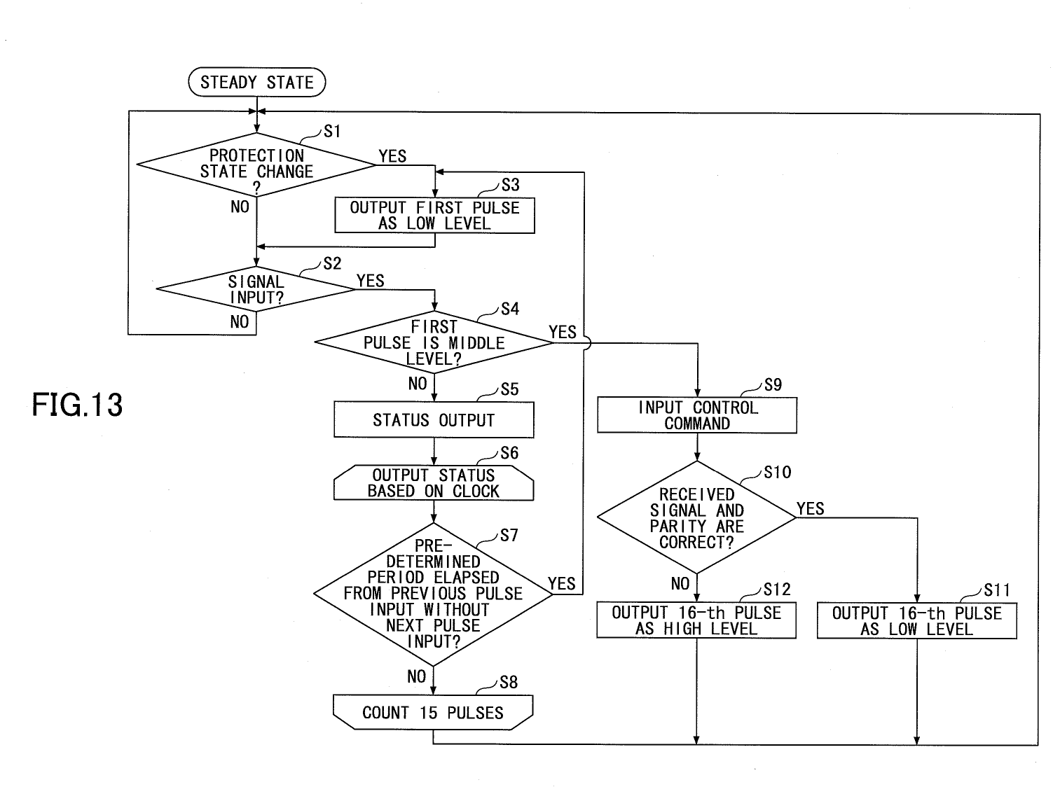

FIG. 13 shows a flowchart of signal output processing performed by the protection IC 12. As shown in FIG. 13, in the steady status, the protection IC 12 determines whether the protection status is changed, that is, determines whether the protection status is changed from the steady status to an abnormal status and the like in step Sl. If there is no change of the protection status, the protection IC 12 determines whether there is an input signal from the terminal ICOM in step S2. If there is no input signal, the process goes to step S1.

In the case when it is determined that there is a change of the protection status in step S1, the protection IC outputs the first pulse as the low level from the terminal ICOM so as to report the interruption receiving mode to the battery monitor IC 11, and the process goes to step S2. Then, when there is an input signal in step S2, the protection IC 12 determines whether the first pulse of the terminal ICOM is at the middle level in step S4.

If the first pulse is not at the middle level in step S4, the mode is the status inquiry command receiving mode or the interruption receiving mode. Thus, the protection IC 12 recognizes output of the status in step S5, and transmits each bit of the status based on the clock in step S6. Next, in step S7, the protection IC 12 determines whether a predetermined period (several times—several tens of times of τ, for example) has elapsed from the time of previous pulse input without input of a next pulse.

In the case when the predetermined period has elapsed without input of a next pulse, it is considered that the low level output in step S3 is not recognized in the battery monitor IC 11, and the process goes to step S3 again so that the process of step S3 is repeated. In the case when there is a next pulse input before elapse of the predetermined period, the protection IC 12 counts 15 pulses of high level in step S8 to complete status transmission of 14 bits. After that, the status returned to the steady state.

On the other hand, if the first pulse is at the middle level in step S4, the mode is the control command transmission mode. Thus, the protection IC 12 receives and inputs each bit of the control command transmitted from the battery monitor IC 11 in step S9. Next, in step S10, the protection IC 12 determines whether odd bits (1), (3), (5), (7), (9), (11) and (13) are the same as even bits (1), (3), (5), (7), (9) and (11) respectively, and determines whether an odd parity calculated from the odd bits (1), (3), (5), (7), (9), (11) and (13) is the same as the check bit of the odd bit (13). When they are the same, that is, when the parity is correct, the protection IC 12 outputs low level from the terminal ICOM in step S11 to report normal reception to the battery monitor IC 11, then, returns to the steady status. When they are not the same, that is, the parity is not correct, the protection IC 12 outputs high level from the terminal ICOM in step S12 to report abnormal reception to the battery monitor IC 11, then, returns to the steady status.

Accordingly, in the present embodiment, bidirectional serial communication can be performed using a single signal line.

Although, in the above-mentioned embodiment, a clock is transmitted from the battery monitor IC 11 with the high level and the middle level and a signal of low level is transmitted from the protection IC 12 for performing bidirectional communication, bidirectional communication may be also performed by transmitting a clock from the battery monitor IC 11 with the low level and the middle level and by transmitting a signal of high level from the protection IC 12. The method for performing bidirectional communication is not limited to the above-embodiment.

The present invention is not limited to the specifically disclosed embodiments, and variations and modifications may be made without departing from the scope of the present invention.

What is claimed is:

1. A communication system comprising a first device and a second device that are connected by a single signal line in which serial communication is performed by using a first level, a second level and a middle level between the first level and the second level, wherein
the first device transmits a clock to the second device by repeating the first level and the middle level;
the second device transmits information to the first device based on whether the second device outputs the second level during each period of the middle level in the clock; and
when the second device does not transmit information, the first device transmits information to the second device based on whether the first device outputs the second level during each period of the middle level in the clock.

2. The communication system as claimed in claim 1, wherein the first device transmits information to the second device after outputting the middle level first.

3. The communication system as claimed in claim 2, wherein the first device receives information transmitted from the second device after outputting the second level first.

4. The communication system as claimed in claim 3, wherein the second device transmits information to the first device after outputting the second level first.

5. The communication system as claimed in claim 4, wherein the first device receives information transmitted from the second device if the first device receives the second level within a predetermined period after outputting the middle level or the second level first.

6. The communication system as claimed in claim 5, wherein the first device is a battery monitor integrated circuit configured to monitor charging and discharging of a secondary battery.

7. The communication system as claimed in claim 6, wherein the second device is a protection integrated circuit configured to control charging and discharging of the secondary battery.

8. A device in a communication system comprising a first device and a second device that are connected by a single signal line in which serial communication is performed by using a first level, a second level and a middle level between the first level and the second level, the device corresponding to the first device, the device comprising:
a unit configured to transmit a clock to the second device by repeating the first level and the middle level; and
a unit configured to transmit information to the first device based on whether to output the second level during each period of the middle level in the clock when the second device does not transmit information.

9. A device in a communication system comprising a first device and a second device that are connected by a single signal line in which serial communication is performed by using a first level, a second level and a middle level between the first level and the second level, the device corresponding to the second device, the device comprising:
a unit configured to receive a clock in which the first level and the middle level are repeated from the first device; and
a unit configured to transmit information to the first device based on whether to output the second level during each period of the middle level of the clock.
